(19) United States
(12) Patent Application Publication
(10) Pub. No.: US 2011/0137628 A1
(43) Pub. Date: Jun. 9, 2011

(54) METHOD FOR TRANSFORMATION AND IMAGING OF ELECTROMAGNETIC SURVEY DATA FOR SUBMARINE HYDROCARBON RESERVOIRS

(76) Inventors: Jostein Kåre Kjerstad, Stavanger (NO); Pavel Barsukov, Moscow (RU); Eduard B. Fainberg, Amersfoort (NL)

(21) Appl. No.: 13/002,457

(22) PCT Filed: Jul. 3, 2009
(86) PCT No.: PCT/NO2009/000250

§ 371 Date: Jan. 19, 2011

(30) Foreign Application Priority Data
Jul. 7, 2008 (NO) 20083007

(51) Int. Cl. G06F 17/10; G06F 19/00; G01V 3/12

(52) U.S. Cl. 703/2; 702/11

(57) ABSTRACT

A method for processing, transforming and mapping subsea survey data arranged to detect earth formations including hydrocarbon reservoirs is proposed. The method differs from known methods by including a real configuration of the sounding system and parameters for a given area of a reference model and by a method for processing and transforming the measured signals.

The invention relates to a method for the analysis, processing and transformation of electromagnetic field data with the aim of mapping earth formations including hydrocarbon reservoirs. One application of the invention is the imaging and inversion of electromagnetic field data measured during marine surveying by the use of TEMP-VEL/OEL hydrocarbon prospecting systems.

TEMP-VEL (=Transient Electromagnetic Marine Prospecting-Vertical Electric Lines) and TEMP-OEL (=Transient Electromagnetic Marine Prospecting-Orthogonal Electric Lines) hydrocarbon prospecting systems are described in NO patent 323889 and NO application 20065436, respectively, incorporated herein by reference in their entirety.

Existing methods of Controlled Source Electromagnetic (CSEM) hydrocarbon surveying are typically based on a simplified, qualitative form of presentation and visualization of field data, in which hydrocarbon reservoirs are discriminated as a local anomaly. When imaging and mapping marine hydrocarbon survey results or when inverting and interpreting the data, the researchers sometimes confine themselves through general words like: “ . . . analysis includes comparing the results of the measurements taken with the results of a mathematical simulation model based on the known properties of the reservoir and overburden conditions” (Eidesmo et al. 2006 (U.S. Pat. No. 7,026,819)).

Srnka (1986 (U.S. Pat. No. 4,617,518)) proposed to make measurements of an electric field with electrodes separated by some distance, at two or more frequencies, and to use them to determine an average resistivity of a portion of the region located within different depths from the sea floor. This is a virtual description of a common method, VES, which is widely used on shore.

Eidesmo et al. (2002); Ellingsrud et al. (2002); Amundsen et al. (2004); Johansen et al. (2005) etc. used the simplest transformation as the electromagnetic field response measured along some profile at some frequency was normalized to the response measured at some reference point located outside the region in which a subterranean hydrocarbon reservoir was assumed or known to exist. This method has the advantage that it excludes the configuration of the transmitter and the intensity of the transmitter current, but the anomaly value in this method depends, to a great degree, on the response at the reference point and may sometimes be very coarse because of the small amplitude of the electric field at the reference point. In addition, this transformation has low resolution and describes the survey results expressed in dimensionless values for the electric field instead of the natural parameters for electric prospecting, namely resistivity and depth.

Wright et al. (2006 (EP 1 425 612)) proposed in their invention “ . . . to make multichannel transient measurements (MTEM) . . . of impulse response of the earth and display it or to make transformation of such impulse responses, to create representation of resistivity contrasts”. There is no description of a possible transformation in the invention.

Apparent resistivity is often used to transform the field data of the field measured. The apparent resistivity has substantial advantages with respect to electromagnetic field because it provides sufficient perception of the seabed structure.

The value of apparent resistivity is normally determined as the resistivity of a homogenous half-space having (with a given transmitter/receiver setup) the same impulse response as that registered in field trials.

For marine applications, Edwards et al. (1984) have proposed the MOSES method with data imaging in the form of apparent resistivity as

$${ρ}_{a} = {ρ}_{0} \frac{Id}{2 π {r}^{2} {H}_{ϕ}} ,$$

in which ρ₀ is sea water resistivity, d is sea depth, I is electrical current from transmitter, r is the distance between the transmitter and receiver, H_{φ} is the azimuth component of the magnetic field measured on the sea floor. This formula is valid with some limitations, namely: the length of the vertical transmitter line equals the sea depth, the ratio between the average resistivity of the first crust layer and that of the sea water is larger than 10, so this formula is valid only for shallow water and does not give a good approximation in deep sea.

Another formula for apparent resistivity was proposed by Wolfgram et al. (1986):

$${ρ}_{a} = {ρ}_{0} \cdot \frac{I}{2 π {rH}_{ϕ}} \cdot \frac{d}{\sqrt{{d}^{2} + {r}^{2}}} - {ρ}_{0} .$$

This formula assumes that the upper electrode is at infinity, and is valid for shallow sea only, that is when d/r<10.

Chen and Oldenburg (2006) substantially improved both Edward's and Wolfgram's formulas and considered a more common 1D earth reference model consisting of a two-layer structure excited by a semi-infinite electrode. Their formulas are based on a semi-analytical term for the magnetic field and can be used for both shallow and deep water.

It has been found in electric prospecting that the methods operating in the time domain provide higher resolution with respect to hydrocarbon targets than the direct current or alternating current methods. In what follows, we confine ourselves to assessing EM sounding in the time domain, more particularly by TEMP-VEL/OEL methods (Barsukov et al. 2007 (WO 2007/053025)). As proposed here, after some modifications, the method and algorithm can be used for both sounding in the frequency domain and direct current.

In the time domain, the response for a homogenous half-space is calculated analytically for any time τ if it is possible, or by using asymptotic formulas for late or early times (Kaufmann and Keller, 1983; Spies and Frischknecht, 1991; Wilt and Stark, 1982; etc.) For a transient electric dipole-dipole setup, Edwards (1997) has proposed the formula

$${ρ}_{a} = {E}_{r} \frac{2 π {r}^{3}}{I Δ I}$$

which transforms the electric field response into apparent resistivity. Here, Eᵣ is the in-line component of the electric field measured by a receiver placed at a distance r from the electric dipole transmitter, IΔI is the moment of the transmitter. This formula does not consider the sea depth, real length of line, time delay, as it assumes that the ratio between the average resistivity of the first crust layer and that of the sea water is larger than 10. These conditions evidently limit the possibilities of such transformation.

The invention has for its object to remedy or reduce at least one of the drawbacks of the prior art.

The object is achieved through features which are specified in the description below and in the claims that follow.

A method for fast imaging and inversion of marine CSEM survey data based a 1D two-layer reference model excited by arbitrary current and measured by an arbitrary receiver is proposed here.

In a first aspect the invention relates, more specifically, to a method for imaging, transforming and mapping electromagnetic data from marine hydrocarbon surveying, the method being characterized by including the following steps:

a) carrying out a marine survey by and measurements of electromagnetic response excited in the earth by a controlled source;
b) analysing said electromagnetic response, approximation of the measured response by a smooth curve;
c) determining first derivatives of said electromagnetic response;
d) transforming said approximation and first derivatives into a graph of resistivity versus depth;
e) using said graph for imaging and mapping earth formations, including hydrocarbon reservoirs;
f) using said graph when constructing a base model for inversion.

The electromagnetic response may be measured in the time domain.

Additional information and constrains may be used in the procedure for the approximation of the measured time response by a smooth curve.

Additional information and constrains may be used in the procedure for determining first time derivatives.

A graph of apparent resistivity versus time may be constructed in addition to a graph of resistivity versus depth.

Both the graph of apparent resistivity versus time and the graph of resistivity versus depth can be used for imaging and mapping earth formations, including hydrocarbon reservoirs.

The graph of resistivity versus depth and first derivatives can be used when a base model for inversion is constructed.

Electromagnetic response may be measured and first derivatives calculated and used when a base model for inversion in the frequency domain is constructed.

In a second aspect, the invention relates to a computer apparatus characterized by having installed machine-readable instructions for implementing the method for imaging, trans-forming and mapping electromagnetic marine hydrocarbon survey data in accordance with the method described above.

In what follows is described an example of a preferred embodiment which is visualized in the accompanying drawings, in which:

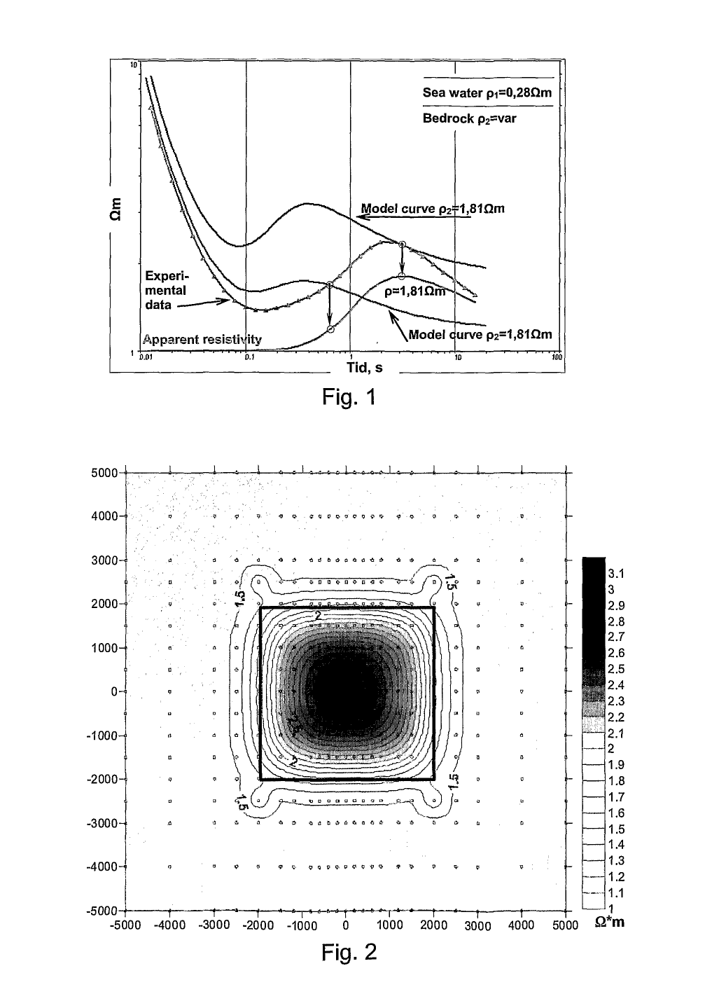

FIG. 1 shows the structural plan of a curve of apparent resistivity;

FIG. 2 demonstrates mapping of apparent resistivity;

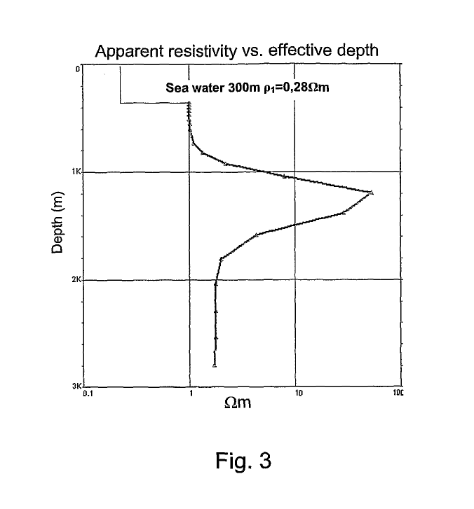

FIG. 3 illustrates the transformation of TEMP-VEL response into apparent resistivity; and

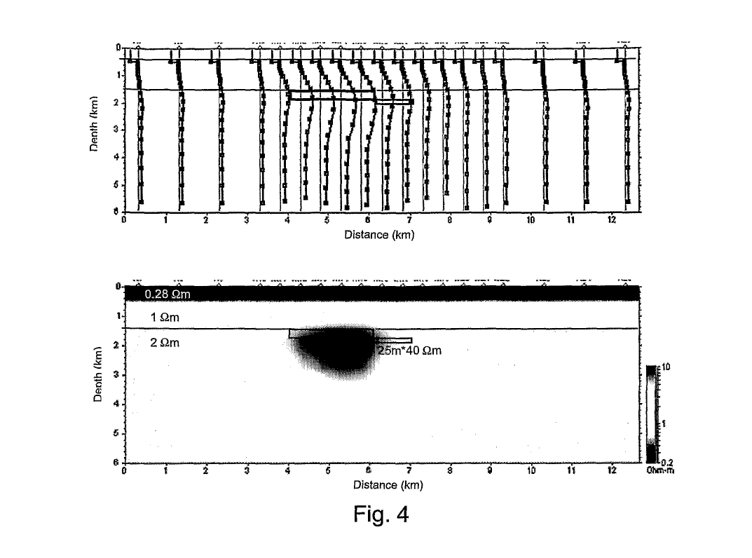

FIG. 4 shows the results of a mapping of the Troll region received from 3D simulated response functions (voltage) transformed into resistivity versus depth in accordance with the proposed method. Rectangles in both pictures show the geometries of real reservoirs. The upper picture presents the section in a “logging” manner and the lower picture in an “imaging” manner.

The method for visualization and inversion is carried out in two phases.

Phase 1: constructing a curve of apparent resistivity ρₐ(t). This phase consists of three sequential steps.

Step 1: Approximation of the measured electromagnetic response and calculation of first derivatives.

This procedure is unstable and needs stabilizing. Some constrains and additional information should be used for stabilization; for example approximation of the field by superpositioning of exponential functions (Barsukov, Svetov, 1984):

$$E ( t ) = {\int }_{0}^{∞} E ( s ) {e}^{- st} d s \qquad ( 1 )$$

Here, E(s) is the exponential spectrum which is determined from the measured data. First derivatives are calculated from E(s) and (1).

After the approximation of field data by a smooth curve, it is appropriate to present the field response in the form of a curve of apparent resistivity versus time—step 2.

Step 2: Presentation of the response in the form of a curve of apparent resistivity versus time.

To begin with, we use an asymptotic formula describing the behaviour of electromagnetic fields in the near or far zone, in full-space or half-space or two-layer models, to build a first approximation of apparent resistivity.

For the TEMP-VEL/OEL method the presentation of the response function based on the calculation of apparent resistivity according to the asymptotic behaviour in the last stage of electric fields across a two-layer structure is quite practical for the calculation of the first approximation of apparent resistivity:

ρ={μ₀^{5/2}*P*h₀²/(20*π^{3/2}*U)*[t^{-5/2}−(t+pulse)^{-5/2}]}^{2/3} (2)

Here, P=TR_len*REC_len (m×m); TR_len and REC_len are the lengths of the transmitter line and receiver line, respectively; h₀=sea depth−TR_len/2 (m); t is the time (in seconds); pulse is the pulse current duration (in seconds); U is the signal normalized to pulse current (V/A); μ₀=4π×10⁻⁷ H/m. FIG. 1 (smooth-lined “field data” marked with triangular field dots) shows an example of a curve of apparent resistivity for a two-layer model shown in the upper right-hand corner of the figure.

Step 3: Transformation of the response function into apparent resistivity ρₐ(t).

The use of asymptotic formulas which are valid in the late stage for the transformation of the measured voltage (electric field) into apparent resistivity, loses information in an early stage of the response function (shallow depth), whereas the use of asymptotic formulas which are valid in the early stage loses information on the deep-lying structure in the section.

These drawbacks are absent when formulas which are accurate for the full transient process are used. In some simple cases it is possible to find accurate formulas for the full transient process. In the normal case (two-layer structure excited by a sloping electric line arbitrarily submerged in the sea and recorded by an arbitrarily submerged, sloping electric receiver line) accurate formulas are absent, and only numerical methods can be used.

In this case, apparent resistivity is determined by solving the non-linear equation p(t)=F(t, h₁, ρ_{b}, ρ₂). FIG. 1 illustrates the solving process. The resistivity ρ₂ at the time t giving the same response (Ωm) as field data (circles) is accepted as apparent resistivity ρₐ at the time t. In inversion and mapping the time scale is replaced with the depth scale. Surface depth is considered as the effective (apparent) sounding depth hₐ: hₐ=\sqrt{2ρₐt/μ₀}.

The curve of apparent resistivity found for all delays contains information about the entire process. Such a curve of apparent resistivity can be used for imaging and mapping field data versus time and be utilized as the base curve for the transformation (inversion) of these data into the curve ρₜᵣ(hₐ).

FIG. 2 illustrates an application of the method described above for the inversion and mapping of TEMP-VEL modelling data calculated for a square target. E_{z}(t)-“field” data was simulated by a 3D program. Parameters of the model are as follows: sea depth is 1 km, its resistivity equals 0.28 Ωm. The square measurement, 4×4 km in size, is located at the depth h=1 km below the sea floor and has a transversal resistance T=2000 Ωm² (thickness of 40 metres and specific resistivity of 50 μm). The map was constructed in accordance with the algorithm described, with a time delay of t=6 s. As it can be seen, the location, size and shape of the target are determined correctly.

Phase 2: Transformation (inversion) of apparent resistivity ρₐ(t) into resistivity ρₜᵣ(hₐ).

The proposed transformation algorithm is as follows.

Define as v=v(t) the logarithmic derivative of apparent resistivity:

$$v = \frac{t}{{ρ}_{a} ( t )} \frac{d {ρ}_{a} ( t )}{d t} = {[ ln {ρ}_{a} ( t ) ]}^{′} , \vert v \vert < 1$$

Let the gain k(t) be

$$k ( t ) = \frac{1}{{( 1 - v )}^{m}} , m = 3 / 2$$

Then the transformed apparent ρₜᵣ(t) resistivity of any time delay t is:

ρₜᵣ(t)=k(t)ρₐ(t)

The gain k(t) and coefficient m=3/2 is used to correct the extra increase in rising branches of the curves of trans-formed apparent resistivity and the extra decrease in falling branches. The effective (apparent) depth hₐ for any time t is calculated as:

$${h}_{a} = \sqrt{\frac{t β ( res )}{{μ}_{0}}} , {μ}_{0} = 4 {π10}^{- 7} H / m$$

$$ln ( β ( res ) ) = ln ( {ρ}_{a} ) + \frac{ln ( {ρ}_{tr} ) - ln ( {ρ}_{a} )}{10} * res , 0 \leq res \leq 10$$

The function β(res) is analogous to resistivity, has the dimension [Ωm] and is inserted into the algorithm to control the resolution of transformation. The β(res) value may be changed within the range from ρₐ(t) (“non-transformed” apparent resistivity) to ρₜᵣ(t) and substantially alter the shape of the curve of apparent resistivity ρₜᵣ(hₐ). β→ρₜᵣ in the case of a low-contrast medium, β→ρₐ for a high-contrast medium and β=(ρₜᵣρₐ)^{1/2} in a medium-contrast medium. The relationship between ρₜᵣ and ρₐ in β(res) is adjusted by the special parameter “res”—“resolution of transformation”.

The method described transforms the measured voltage response into an electrical cross-section—resistivity versus depth and actually yields a solution to an inverse problem. It provides a simple and quick tool for visualizing and mapping earth formations which include hydrocarbon reservoirs.

FIG. 3 shows the result of a transformation of TEMP-VEL signals, namely voltage versus time, into apparent resistivity versus depth. Parameters of the model: h₁=300 m, ρ₁=0.28 Ωm, h₂=1400 m, ρ₂=1 Ωm, h₃=40 m, ρ₃=100 Ωm, ρ₄=2 Ωm.

As it can be seen, the transformed curve represents the model section qualitatively correctly.

FIG. 4 illustrates an application of the proposed method for mapping hydrocarbon targets. 3D voltage response for a TEMP-VEL setup was calculated for a simplified model of the Troll region (Johansen et al., 2005) and then transformed into resistivity versus depth.

It is obvious that the proposed method for mapping yields the correct location, size and depth of the target; some reflection underneath the target is the result of the approximation of a small, thin target layer as the continuous function of depth.

The model constructed can be used as a good base model for 3D inversion.

### REFERENCES

| | | |
|---|---|---|
| Publication No. | Published | Inventor |

US patent publications

| | | |
|---|---|---|
| 4,617,518 | October 1986 | Srnka |
| 0052685 A1 | March 2003 | Ellingsrud et al. |
| 0048105 A1 | March 2003 | Ellingsrud et al. |
| 6,628,119 B1 | October 2003 | Eidesmo et al. |
| 2006132137 | June 2006 | MacGregor et al. |
| 7,026,819 | April 2006 | Eidesmo et al. |

Other patent publications

| | | |
|---|---|---|
| WO 01/57555 | A1 September 2001 | Ellingsrud et al. |
| WO 02/14906 | A1 February 2002 | Ellingsrud et al |
| WO 03/025803 | A1 March 2003 | Srnka et al. |
| WO 03/034096 | A1 April 2003 | Sinha et al. |
| WO 03/048812 | A1 June 2003 | MacGregor et al. |
| WO 2004/049008 A1 | April 2004 | MacGregor et al. |
| WO 2006/073315 | January 2006 | Johnstad et al. |
| EP 1 425 612 | B1 February 2006 | Wright et al. |
| WO 2007/053025 | May 2007 | Barsukov et al. |

### Other publications

Amundsen H. E. F., Johansen S., Røsten T., 2004. A Sea Bed Logging (SBL) calibration survey over the Troll Gas Field. 66^{th} EAGE Conference & Exhibition, Paris, France, 6-10 Jun. 2004.
Barsukov P. O., Svetov B. S., 1984. Transformation of quasi-stationary transient process in geoelectrics into equivalent wave processes. //Physics of the Earth, 8, pp. 29-37.
Chen J. and Oldenburg D. W., 2006. A new formula to compute apparent resistivities from marine magnetometric resistivity data. Geophysics, V. 71, pp. G73-G81.
Edwards R. N., 1997. On the resource evaluation of marine gas hydrate deposits using sea-floor transient electric dipole-dipole methods. Geophysics, 1997, V. 62, No. 1, pp. 63-74.
Edwards R. N. Marine control source electromagnetic principles, methodologies, future commercial applications. Survey in Geophysics, 2005, V. 26, pp. 675-700.
Edwards R. N., Nobes D. C., Gomez-Trevino E., 1984. Offshore electrical exploration of sedimentary basins: The effects of anisotropy in horizontally isotropic, layered media. Geophysics, V. 49, No. 5, pp. 566-576.
Eidesmo T., Ellingsrud S., MacGregor L. M., Constable S., Sinha M. C., Johansen S. E., Kong N. and Westerdahl H., 2002. Sea Bed Logging (SBL), a new method for remote and direct identification of hydrocarbon filled layers in deepwater areas. First Break, 20, March, pp. 144-152.
Ellingsrud S., Sinha M. C., Constable S., MacGregor L. M., Eidesmo T. and Johansen S. E., 2002. Remote sensing of hydrocarbon layers by Sea Bed Logging (SBL): results from a cruise offshore Angola. The Leading Edge, 21, pp. 972-982.
Johansen S. E., Amundsen H. E. F., Røsten T., Ellingsrud S., Eidesmo T., Bhuyian A. H., 2005. Subsurface hydrocarbon detected by electromagnetic sounding. First Break, V. 23, pp. 31-36.
Kaufman A. A., Keller G. V., 1983. Frequency and transient sounding, Elsevier Science Publ. Co.
MacGregor L., Sinha M., 2000. Use of marine controlled-source electromagnetic sounding for sub-basalt exploration. Geophysical prospecting. V. 48, pp. 1091-1106.
MacGregor L., Sinha M., Constable S., 2001. Electrical resistivity of the Valu Fa Ridge, Lau Basin, from marine controlled-source electromagnetic sounding. Geoph. J. Intern. V. 146, pp. 217-236.
MacGregor L., Tompkins M., Weaver R., Barker N., 2004. Marine active source EM sounding for hydrocarbon detection. 66^{th} EAGE Conference & Exhibition, Paris, France.
Spies B. R., and Frischknecht F. C., 1991. Electromagnetic sounding. In: Nabighian M. N. Ed. Electromagnetic methods in applied Geophysics, SEG IG, No. 3, pp. 285-425.
Wicklund T. A., Fanavoll S. Norwegian Sea: SBL case study, 2004. EAGE 66^{th} Conference & Exhibition, Paris, France, Extended Abstract Z-99.
Wilt M. and Stark M., 1982. A simple method for calculating of apparent resistivity from electromagnetic sounding data: Geophysics, 47, pp. 1100-1105.
Wolfgram P. A., Edwards R. N., Law L. K., Bone M. N., 1986. Polymetallic sulfide exploration on the deep sea floor. The feasibility of the MINI-MOSES technique. Geophysics, V. 51, pp. 1808-1818.

1. A method for imaging, transforming and mapping electromagnetic data from marine hydrocarbon surveying, said method comprising the following steps:
a) marine surveying by and measurements of electromagnetic response excited in the earth by a controlled source;
b) analysis of said electromagnetic response, approximation of the measured response by a smooth curve;
c) determination of first derivatives of said electromagnetic response;
d) transformation of said approximation and first derivatives into a graph of resistivity versus depth;
e) application of said graph for the imaging and mapping of earth formations, including hydrocarbon reservoirs; and
f) application of said graph when constructing a base mode for inversion.

2. The method as described in claim 1, wherein the electromagnetic response is measured in time domain.

3. The method as described in claim 2, wherein additional information and constrains are used in the procedure for the approximation of the measured time response by a smooth curve.

4. The method as claimed in claim 1 wherein, additional information and constrains are used in the procedure for the determination of first derivatives.

5. The method as described in claim 1, wherein a graph of apparent resistivity versus time is constructed in addition to a graph of resistivity versus depth.

6. The method as described in claim 5, wherein both the graph of apparent resistivity versus time and the graph of resistivity versus depth are used for imaging and mapping earth formations, including hydrocarbon reservoir.

7. The method as described in claim 1, wherein the graph of resistivity versus depth and first time derivatives are used when a base model for invention is constructed.

8. The method as described in claim 1, wherein the electromagnetic response is measured and first derivatives are calculated and used when a base model for inversion in the frequency domain is constructed.

9. A computer apparatus, said apparatus comprising: installed machine-readable instructions for implementing a method for imaging, transforming and mapping electromagnetic marine hydrocarbon survey data including the steps of: marine surveying by and measurements of electromagnetic response excited in the earth by a controlled source; analysis of the electromagnetic response, approximation of the measured response by a smooth curve; determination of first derivatives of the electromagnetic response; transformation of the approximation and first derivatives into a graph of resistivity versus depth; application of the graph for the imaging and mapping of earth formations, including hydrocarbon reservoirs; and application of the graph when constructing a base mode for inversion.
